(19) United States
(12) Patent Application Publication
(10) Pub. No.: US 2023/0288611 A1
(43) Pub. Date: Sep. 14, 2023

(54) LENS MODULE

(71) Applicant: AAC Optics (Suzhou) Co., Ltd., Suzhou City (CN)

(72) Inventors: Huaiyu Chen, Shenzhen (CN); Pingping Wang, Shenzhen (CN)

(21) Appl. No.: 17/835,953

(22) Filed: Jun. 8, 2022

(30) Foreign Application Priority Data
Mar. 9, 2022 (CN) 202210226401.3

(51) Int. Cl. G02B 1/04; G02B 1/10; G02B 7/02

(52) U.S. Cl. CPC G02B 1/041; G02B 1/10; G02B 7/021

(57) ABSTRACT

The present disclosure provides a lens module, including a plurality of plastic lenses, wherein a plastic lens is doped with a material that absorbs a wave with a specific wavelength, and a surface of a plastic lens is coated with an infrared cut-off film or an ultraviolet cut-off film. The lens module provided by the invention reduces a total thickness, simplifies a technological process, improves a angle drift problem, simplifies a technological process and improves an imaging quality.

### TECHNICAL FIELD

The present disclosure relates to the technical field of optical imaging devices, in particular to a lens module.

### BACKGROUND

In recent years, with the rise of various smart devices, the demand for miniaturized photographic optical lenses is increasing. Besides, due to a shrinking pixel size of photosensitive devices, coupled with a development trend of the current electronic products with good functions and lightweight and portable appearance, miniaturized photographic optical lenses with good imaging quality have become a mainstream in the current market. In order to obtain images with better quality, multi-piece lens modules are usually adopted.

A lens module in the related art adopts a white glass as an infrared cut-off filter, which, however, has disadvantages of angle drifting of large incidence angle and thick thickness. Referring to FIG. 1, images captured by the lens module has a ghost effect mainly due to an optical filter, causing imaging quality degradation. As customers' requirements for shooting quality are getting higher and higher, the optical filter is developing towards thin thickness and anti-angle.

Therefore, there is an urgent need to provide a new lens module to solve the above-mentioned technical problems.

### SUMMARY

An object of the present disclosure is to provide a lens module capable of improving imaging quality.

In order to achieve the above-mentioned object, the present disclosure provides a lens module comprising a plurality of plastic lenses, wherein one of the plastic lenses is doped with a material that absorbs a wave with a specific wavelength, and a surface of one of the plastic lenses is coated with an infrared cut-off film or an ultraviolet cut-off film.

In some embodiments, the infrared cut-off film or the ultraviolet cut-off film is coated on a surface of the plastic lens doped with the material that absorbs the wave with the specific wavelength.

In some embodiments, the infrared cut-off film or the ultraviolet cut-off film is coated on the surface of the plastic lens by evaporation or sputtering.

In some embodiments, the surface of the plastic lens is entirely coated with the infrared cut-off film or the ultraviolet cut-off film.

In some embodiments, the specific wavelength is in a range of 550-800 nm.

In some embodiments, the specific wavelength is in a range of 350-450 nm and 550-800 nm.

In some embodiments, the specific wavelength is in a range of 600-1200 nm.

In some embodiments, an included angle between a tangent line of a point on the surface of the plastic lens coated with the infrared cut-off film or the ultraviolet cut-off film except a surface center and a tangent line of the surface center of the plastic lens is in a range of 0-60°.

In some embodiments, an included angle between a tangent line of a point on the surface of the plastic lens doped with the material that absorbs the wave with the specific wavelength except a surface center and a tangent line of the surface center of the plastic lens is in a range of 0-60°.

In some embodiments, the included angle is in a range of 0-20°.

Compared with the related art, in the lens module provided by the present disclosure, the plastic lens of the lens module is doped with the material that absorbs the wave with the specific wavelength, and the surface of the same plastic lens or the surface of other plastic lens is coated with the infrared cut-off film or the ultraviolet cut-off film, thereby solving the angle drifting problem, reducing the ghost effect and improving image quality.

### BRIEF DESCRIPTION OF THE DRAWINGS

In order to describe the technical solutions in the embodiments of the present disclosure more clearly, accompanying drawings required to be used in the descriptions of the embodiments will be briefly introduced below. Obviously, the drawings in the illustration below are merely some embodiments of the present disclosure. Those ordinarily skilled in the art also can acquire other drawings according to the provided drawings without doing creative work.

FIG. 1 is a schematic diagram of a ghost effect caused by a lens module in the related art.

FIG. 2 is a schematic structural diagram of a lens module according to the present disclosure.

FIG. 3 is a transmittance curve diagram of the lens module when a light shines on a plastic lens doped with a material that absorbs a wave with a specific wavelength according to Embodiment 1 of the present disclosure.

FIG. 4 is a transmittance curve diagram of the lens module when the light shines on a plastic lens coated with an infrared cut-off film or an ultraviolet cut-off film in an object side or an image side according to Embodiment 1 of the present disclosure.

FIG. 5 is a transmittance curve diagram of the lens module when the light shines on a plastic lens or a plastic lens combination doped with the material that absorbs the wave with the specific wavelength and coated with the infrared cut-off film or the ultraviolet cut-off film in the object side or the image side according to Embodiment 1 of the present disclosure.

FIG. 6 is a schematic diagram of a ghost effect caused by the lens module according to Embodiment 1 of the present disclosure.

FIG. 7 is a transmittance curve diagram of the lens module when the light shines on the plastic lens doped with a material that absorbs a wave with a specific wavelength according to Embodiment 2 of the present disclosure.

FIG. 8 is a transmittance curve diagram of the lens module when the light shines on the plastic lens coated with the infrared cut-off film or an ultraviolet cut-off film in the object side according to Embodiment 2 of the present disclosure.

FIG. 9 is a transmittance curve diagram of the lens module when the light shines on the plastic lens coated with the infrared cut-off film or an ultraviolet cut-off film in the image side according to Embodiment 2 of the present disclosure.

FIG. 10 is a transmittance curve diagram of the lens module when the light shines on the plastic lens or the plastic lens combination doped with the material that absorbs the wave with the specific wavelength and coated with the infrared cut-off film or the ultraviolet cut-off film in the object side or the image side according to Embodiment 2 of the present disclosure.

FIG. 11 is a schematic diagram of a ghost effect caused by the lens module according to Embodiment 2 of the present disclosure.

FIG. 12 is a transmittance curve diagram of the lens module when the light shines on the plastic lens doped with the material that absorbs the wave with the specific wavelength according to Embodiment 3 of the present disclosure.

FIG. 13 is a transmittance curve diagram of the lens module when the light shines on the plastic lens coated with the infrared cut-off film or the ultraviolet cut-off film in the object side or the image side according to Embodiment 3 of the present disclosure.

FIG. 14 is a transmittance curve diagram of the lens module when the light shines on the plastic lens or the plastic lens combination doped with the material that absorbs the wave with the specific wavelength and coated with the infrared cut-off film or the ultraviolet cut-off film in the object side or the image side according to Embodiment 3 of the present disclosure.

FIG. 15 is a schematic diagram of a ghost effect caused by the lens module according to Embodiment 3 of the present disclosure.

FIG. 16 is a transmittance curve diagram of the lens module when the light shines on the plastic lens doped with the material that absorbs the wave with the specific wavelength according to Embodiment 4 of the present disclosure.

FIG. 17 is a transmittance curve diagram of the lens module when the light shines on the plastic lens coated with the infrared cut-off film or the ultraviolet cut-off film in the object side or the image side according to Embodiment 4 of the present disclosure.

FIG. 18 is a transmittance curve diagram of the lens module when the light shines on the plastic lens or the plastic lens combination doped with the material that absorbs the wave with the specific wavelength and coated with the infrared cut-off film or the ultraviolet cut-off film in the object side or the image side according to Embodiment 4 of the present disclosure.

FIG. 19 is a reliability test diagram of the lens module with the plastic lens doped with the material that absorbs the wave with the specific wavelength according to the present disclosure.

FIG. 20 is a reliability test diagram of the lens module with the plastic lens coated with the infrared cut-off film or the ultraviolet cut-off film the present disclosure.

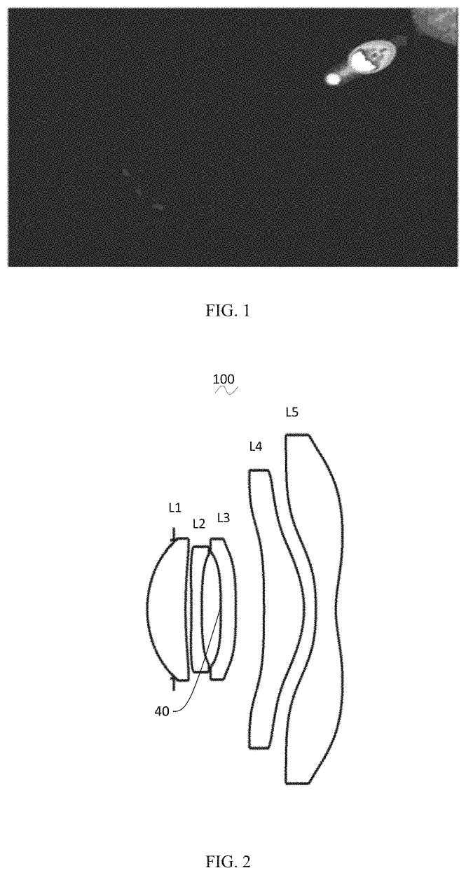

### DETAILED DESCRIPTION OF THE EMBODIMENTS

The technical solutions in the embodiments of the present disclosure will be described clearly and completely below with reference to the drawings in the embodiments of the present disclosure. Obviously, the embodiments described herein are only part of the embodiments of the present disclosure, not all the embodiments. Based on the embodiments in the present disclosure, all other embodiments obtained by those of ordinary skill in the art without creative work shall fall within the protection scope of the present disclosure.

Referring to FIG. 2, the present disclosure provides a lens module 100, including a plurality of plastic lenses. In this embodiment, five lenses are adopted as an example, which includes a first lens L1, a second lens L2, a third lens L3, a third lens, a fourth lens L4 and a fifth lens L5.

The third lens L3 is a plastic lens and is doped with a material that absorb a wave with a specific wavelength. Specifically, a twin-screw extrusion device may be used to mix plastic particles with dyes that absorb the wave with the specific wavelength in a certain proportion and then granulate. The dyes may be, but are not limited to, phthalocyanine dyes, indocyanine dyes and organic metal absorbers. In the third lens L3, that is, a plastic lens doped with materials that absorb the wave with the specific wavelength, an included angle between a tangent line of a point on the surface of the plastic lens except a surface center and a tangent line of the surface center of the plastic lens is in a range of 0-60°. Preferably, the included angle is 0-20°.

In addition, the fourth lens L4 is also a plastic lens, and a surface of the fourth lens L4 is coated with an infrared cut-off film or an ultraviolet cut-off film 40. Specifically, an Infrared-Radiation Cut Filter (IRCF) technology may be used for coating, that is, a Physical Vapor Deposition (PVD) evaporation or sputtering device is used, and high refractive index and low refractive index materials are alternately coated according to the thin film design through an ion source-assisted deposition process. The high refractive index materials include titanium pentoxide, tantalum pentoxide, niobium pentoxide and hafnium oxide. The low refractive index materials include silicon dioxide, magnesium fluoride and silicon-aluminum mixture. In the fourth lens L4, that is, the plastic lens coated with the infrared cut-off film or the ultraviolet cut-off film, an included angle between a tangent line of a point on the surface of the plastic lens except a surface center and a tangent line of the surface center of the plastic lens is in a range of 0-60°. In some embodiments, the included angle is 0-20°.

In this embodiment, the lens doped with the material that absorbs the wave with the specific wavelength and the lens coated with the infrared cut-off film or the ultraviolet cut-off film are not the same lens. In other embodiments, the same lens may be doped with a material that absorbs the wave with the specific wavelength and coated with the infrared cut-off film or the ultraviolet cut-off film. In addition, the infrared cut-off film or the ultraviolet cut-off film may be located on an object side of the lens, or on an image side of the lens, or one side is the infrared cut-off film or the ultraviolet cut-off film, and the other side is an anti-reflection film.

### Embodiment 1

For example, the specific wavelength is in a range of 550-800 nm. Only the object side or the image side of the plastic lens is coated with the infrared cut-off film or the ultraviolet cut-off film, and a thickness of the infrared cut-off film or the ultraviolet cut-off film is in a range of 4-6 μm.

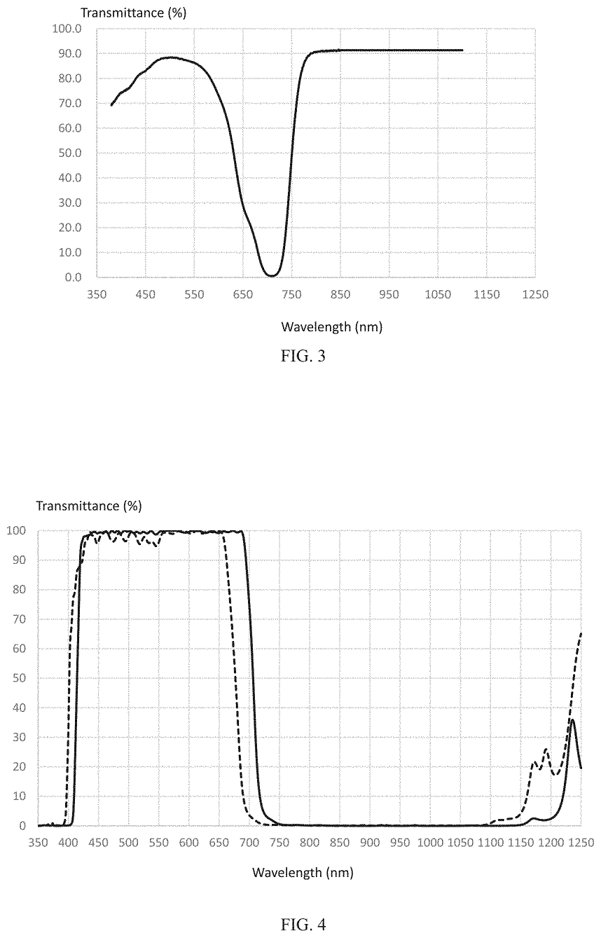

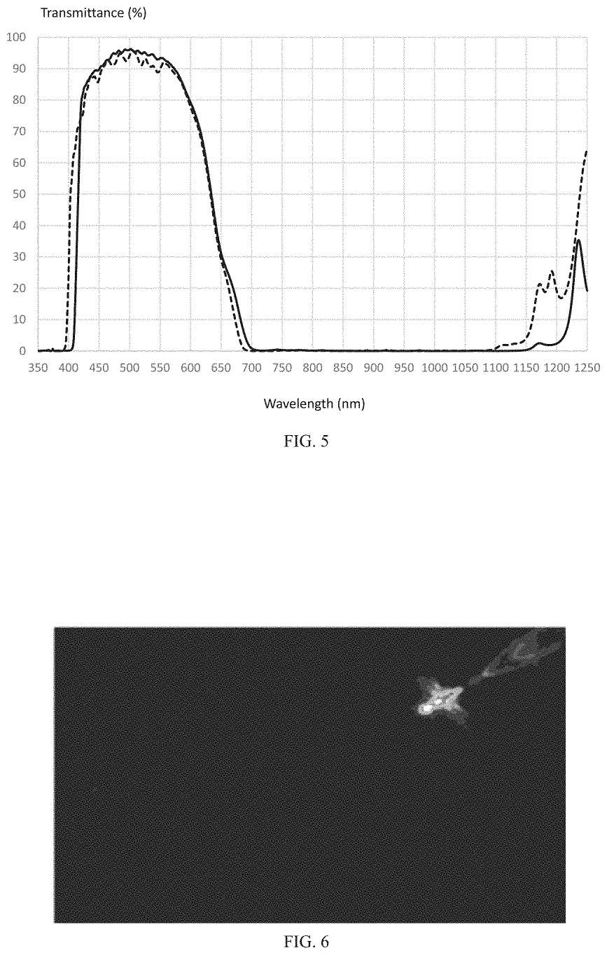

FIG. 3 is a transmittance curve diagram of the lens module when a light shines on the plastic lens doped with the material that absorbs the wave with the specific wavelength. FIG. 4 is a transmittance curve diagram of the lens module when the light shines on an object side or an image side coated with the infrared cut-off film or the ultraviolet cut-off film of the plastic lens, in which a solid line is an incident angle of 0°, and a dotted line is an incident angle of 30°. There is an angle drifting problem at the incident angles of 0° and 30°, which will affect an imaging quality of the lens module. FIG. 5 is a transmittance curve diagram when the light shines on a plastic lens or a plastic lens combination doped with the material that absorbs the wave with the specific wavelength and coated with the infrared cut-off film or the ultraviolet cut-off film in the object side or the image side, in which a solid line is an incident angle of 0°, a dotted line is an incident angle of 30°, and the angle drifting is significantly reduced. Referring to FIG. 6, compared with the related art, a ghost effect caused by a reflection between the lenses is newly added, and there is no ghost effect caused by an internal reflectance caused by the surface of the plastic lens coated with the infrared cut-off film or the ultraviolet cut-off film, and there is no ghost effect related to the optical filter in the related art. It can be seen that by doping the plastic lens of the lens module with the material that absorbs the wave with specific wavelength and coating the surface of the same plastic lens or other plastic lens with the infrared cut-off film or the ultraviolet cut-off film, the problem of angle drifting can be solved, and the ghosting phenomenon is reduced and the imaging quality is improved.

### Embodiment 2

For example, the specific wavelength is in a range of 550-800 nm. The object side and the image side of the plastic lens are coated with the infrared cut-off film or the ultraviolet cut-off film, and a thickness of the infrared cut-off film or the ultraviolet cut-off film is in a range of 2-4 μm.

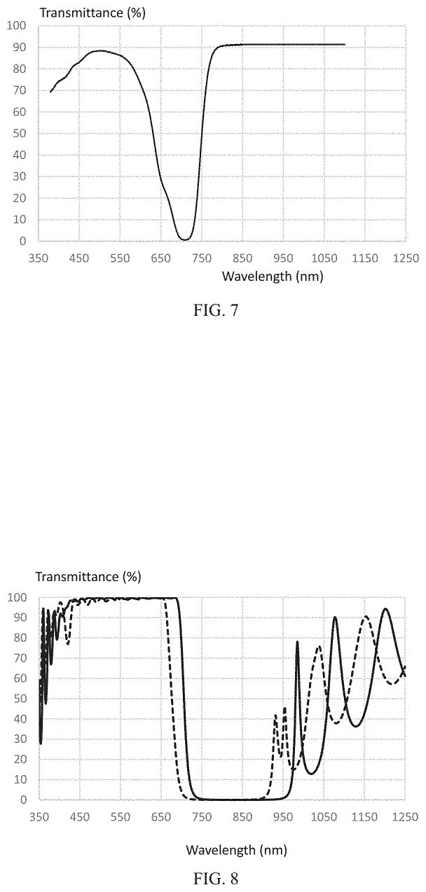

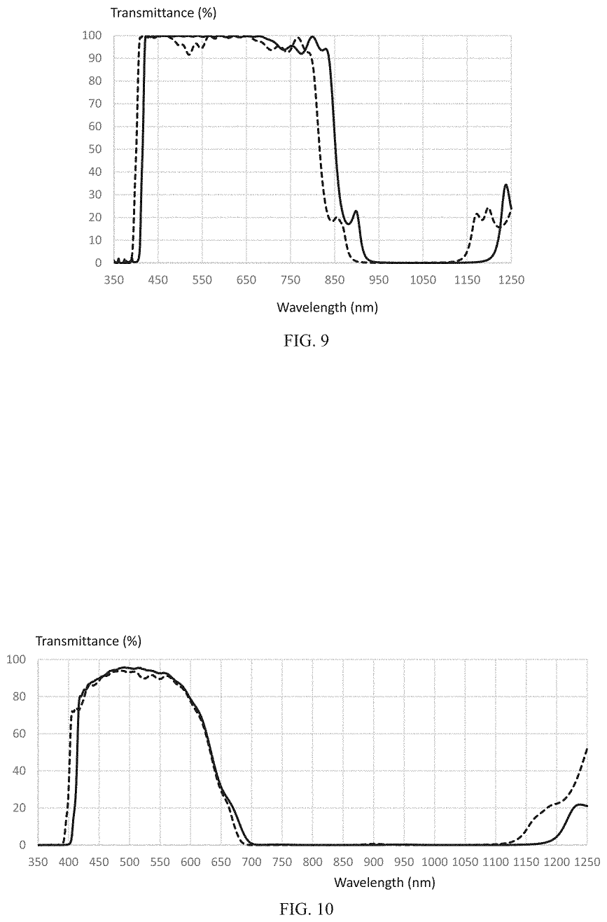

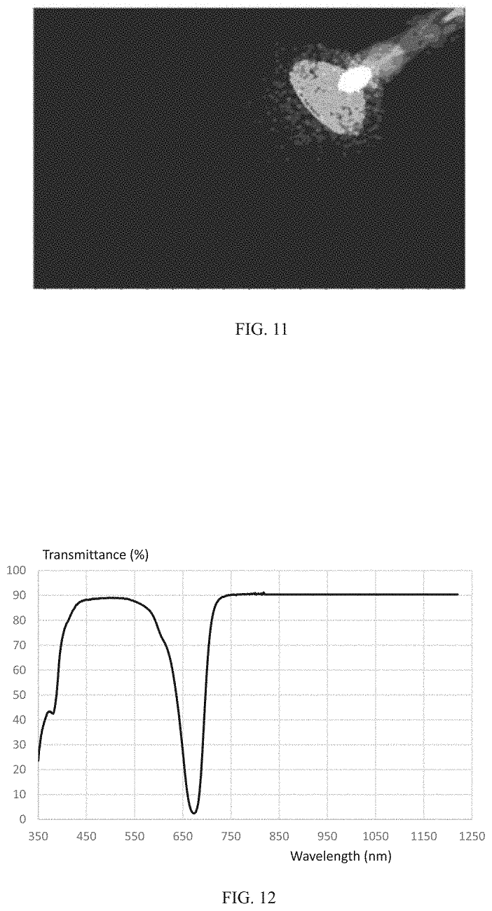

Referring to FIGS. 7-10, a solid line is the incident angle of 0°, and the dotted line is the incident angle of 30°. A plastic lens or a plastic lens combination doped with the material that absorbs the wave with the specific wavelength and coated with the infrared cut-off film or the ultraviolet cut-off film may reduce the angle drifting. Referring to FIG. 11, compared with the related art, there is a ghost effect with internal reflectance caused by the surface of the plastic lens coated with the infrared cut-off film or the ultraviolet cut-off film, which has a high the intensity. There is no ghost effect related to the optical filter in the prior art.

### Embodiment 3

For example, the specific wavelength is in a range of 350-450 nm and 550-800 nm. The object side and the image side of the plastic lens are coated with the infrared cut-off film or the ultraviolet cut-off film, and a thickness of the infrared cut-off film or ultraviolet cut-off film is in a range of 1-2 μm.

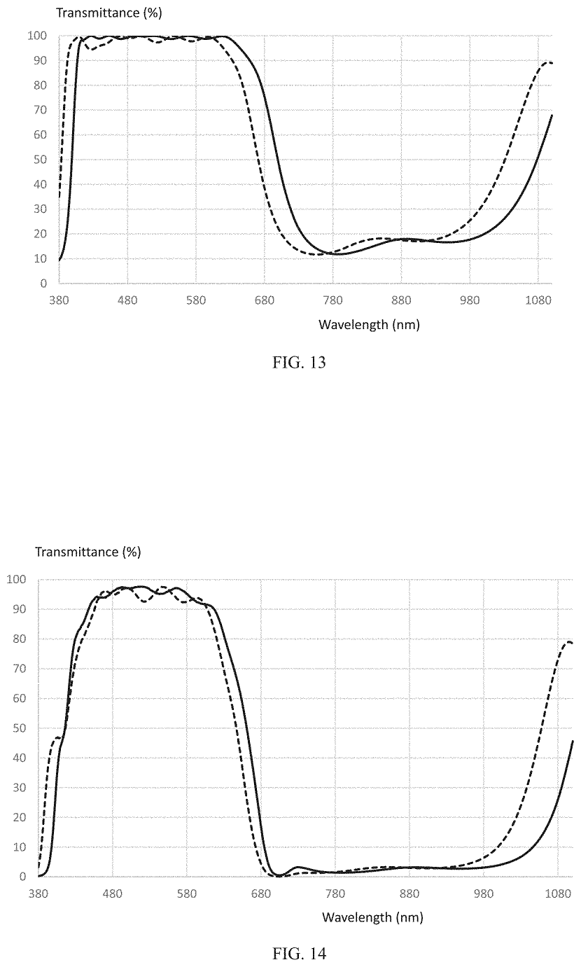

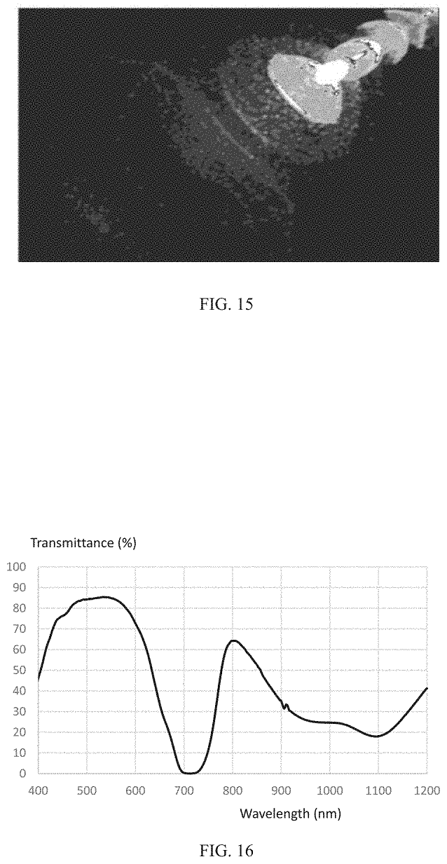

Referring to FIGS. 12-14, a solid line is an incident angle of 0°, and a dotted line is an incident angle of 30°. A plastic lens or a plastic lens combination doped with the material that absorbs the wave with the specific wavelength and coated with the infrared cut-off film or the ultraviolet cut-off film may reduce the angle drifting. Referring to FIG. 15, compared with the related art, there is a ghost effect with internal reflectance caused by the surface of the plastic lens coated with the infrared cut-off film or the ultraviolet cut-off film, which has a high intensity. There is no ghost effect related to the optical filter in the prior art.

### Embodiment 4

For example, the specific wavelength is in a range of 600-1200 nm. Only the object side or the image side of the plastic lens is coated with the infrared cut-off film or the ultraviolet cut-off film, and a thickness of the infrared cut-off film or ultraviolet cut-off film is in a range of 4-6 μm.

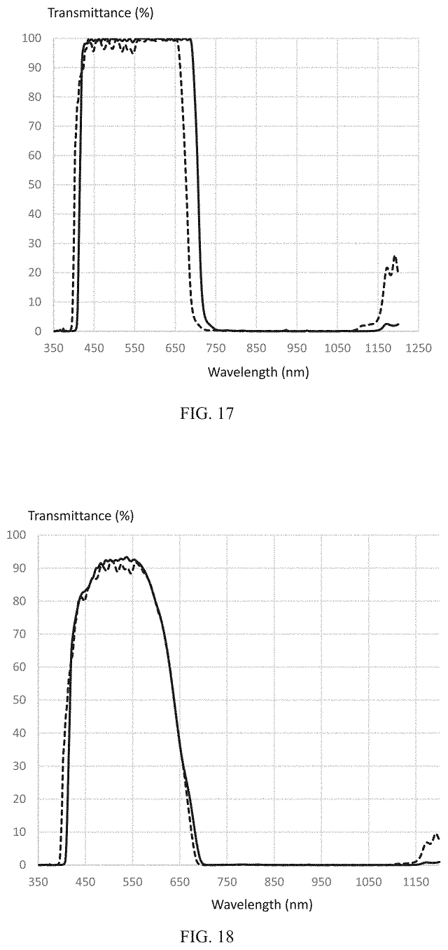

Referring to FIGS. 16-18, a solid line is an incident angle of 0°, and a dotted line is the incident angle of 30°. A plastic lens or a plastic lens combination doped with the material that absorbs the wave with the specific wavelength and coated with the infrared cut-off film or the ultraviolet cut-off film may reduce the angle drifting.

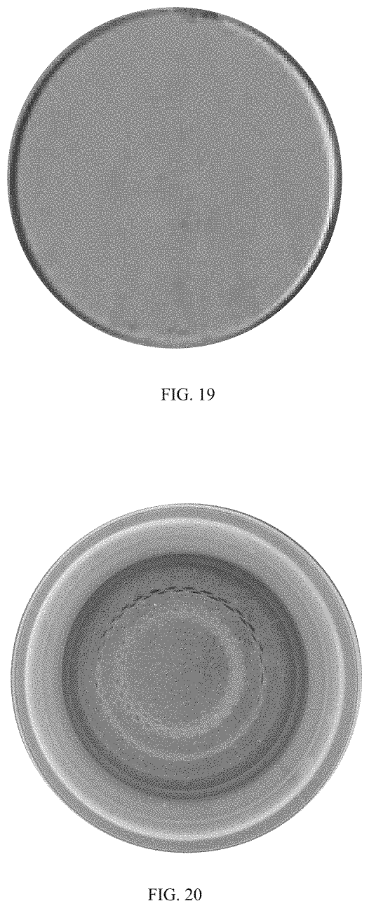

In addition, as shown in the Table 1 below, in a reliability test, in different test environments, the plastic lenses doped with the material that absorbs the wave with the specific wavelength and the plastic lenses coated with infrared cut-off film or ultraviolet cut-off film are all intact. As shown in FIG. 19, the plastic lens doped with the material that absorbs the wave with the specific wavelength of Embodiment 1 is taken as an example, in which the plastic lens is intact without the phenomenon of cracking, falling off or fogging. As shown in FIG. 20, the surface of the plastic lens of the Embodiment 1 coated with the infrared cut-off film or the ultraviolet cut-off film is taken as an example, in which the plastic lens is intact without the phenomenon of cracking, falling off or fogging. Specifically, the test environments are: high temperature: 85° C.±2° C., 480 h; low temperature: −40° C.±2° C., 480 h; high temperature and high humidity: 85° C.±2° C., 85%±5% RH, 480 h; hot and cold shock: 120 cycles; 1 cycle: −40° C. (30 minutes), 85° C. (30 minutes), 480 h.

TABLE 1

| | High | | | |
|---|---|---|---|---|
| | temperature and | High | Low | Hot and |
| | high humidity | temperature | temperature | cold shock |
| Embodiment | 480 h | 480 h | 480 h | 480 h |
| 1 | Intact | Intact | Intact | Intact |
| 2 | Intact | Intact | Intact | Intact |
| 3 | Intact | Intact | Intact | Intact |
| 4 | Intact | Intact | Intact | Intact |

In the lens module provided by the present disclosure, the plastic lens of the lens module is doped with the material that absorbs the wave with the specific wavelength, and the surface of the same plastic lens or the surface of other plastic lens is coated with the infrared cut-off film or the ultraviolet cut-off film, thereby solving the angle drifting problem, reducing the ghost effect and improving image quality. In addition, the original optical filter may also be canceled, thereby reducing a total optical length of the lens module, improving a degree of freedom of the lens design, simplifying a technological process and reducing a production cost.

The embodiments of the present disclosure are described above only. It should be noted that those of ordinary skill in the art can further make improvements without departing from the concept of the present disclosure. These improvements shall all fall within the protection scope of the present disclosure.

What is claimed is:

1. A lens module comprising:
a plurality of plastic lenses;
wherein one of the plastic lenses is doped with a material that absorbs a wave with a specific wavelength, and a surface of one of the plastic lenses is coated with an infrared cut-off film or an ultraviolet cut-off film.

2. The lens module of claim 1, wherein the infrared cut-off film or the ultraviolet cut-off film is coated on a surface of the plastic lens doped with the material that absorbs the wave with the specific wavelength.

3. The lens module of claim 1, wherein the infrared cut-off film or the ultraviolet cut-off film is coated on the surface of the plastic lens by evaporation or sputtering.

4. The lens module of claim 1, wherein the surface of the plastic lens is entirely coated with the infrared cut-off film or the ultraviolet cut-off film.

5. The lens module of claim 1, wherein the specific wavelength is in a range of 550-800 nm.

6. The lens module of claim 1, wherein the specific wavelength is in a range of 350-450 nm and 550-800 nm.

7. The lens module of claim 1, wherein the specific wavelength is in a range of 600-1200 nm.

8. The lens module of claim 1, wherein an included angle between a tangent line of a point on the surface of the plastic lens coated with the infrared cut-off film or the ultraviolet cut-off film except a surface center and a tangent line of the surface center of the plastic lens is in a range of 0-60°.

9. The lens module of claim 1, wherein an included angle between a tangent line of a point on the surface of the plastic lens doped with the material that absorbs the wave with the specific wavelength except a surface center and a tangent line of the surface center of the plastic lens is in a range of 0-60°.

10. The lens module of claim 8, wherein the included angle is in a range of 0-20°.
